(19) United States
(12) Patent Application Publication
(10) Pub. No.: US 2025/0309470 A1
(43) Pub. Date: Oct. 2, 2025

(54) NON-AQUEOUS ELECTROLYTE SECONDARY BATTERY

(71) Applicant: Panasonic Energy Co., Ltd., Moriguchi-shi, Osaka (JP)

(72) Inventors: Sota Fukuda, Tokushima (JP); Shinji Kasamatsu, Osaka (JP)

(73) Assignee: Panasonic Energy Co., Ltd., Moriguchi-shi, Osaka (JP)

(21) Appl. No.: 18/866,644

(22) PCT Filed: May 22, 2023
(86) PCT No.: PCT/JP2023/018899

§ 371 Date: Nov. 18, 2024

(30) Foreign Application Priority Data
May 31, 2022 (JP) 2022-088617

(51) Int. Cl. H01M 50/451; H01M 10/0587; H01M 50/46

(52) U.S. Cl. CPC H01M 50/451; H01M 10/0587; H01M 50/461

(57) ABSTRACT

A non-aqueous electrolyte secondary battery comprises an electrode body formed by winding a positive electrode and a negative electrode such that a separator is interposed therebetween; an electrolyte solution; and an outer can for accommodating the electrode body and the electrolyte solution. The separator has a base material layer and a filler layer formed at least on one surface of the base material layer. The filler layer contains inorganic particles and resin particles having a larger average particle diameter than the inorganic particles, and has protruding parts formed from the resin particles. The protruding parts protrude from the inorganic particle layer that is formed of the inorganic particle layer excluding the protruding parts of the filler layer. When the surface of the filler layer is observed by a scanning electron microscope, 10-35 resin particles forming the protruding parts are detected in a range of 100 μm×100 μm.

### TECHNICAL FIELD

The present disclosure relates to a non-aqueous electrolyte secondary battery.

### BACKGROUND ART

In recent years, non-aqueous electrolyte secondary batteries have been widely used as secondary batteries with high output and high energy density. In the non-aqueous electrolyte secondary battery, charge and discharge are performed by transferring lithium ions and the like between a pair of electrode plates (a positive electrode and a negative electrode) through an electrolyte solution. In an electrode assembly, the positive electrode and the negative electrode face each other via a separator, and the separator separates the positive electrode and the negative electrode each other. The separator may have a filler layer for a purpose of improving heat resistance on a surface of a porous substrate layer composed of a polyolefin or the like.

Patent Literature 1 discloses art that, in a pouch-shaped secondary battery, two polymers having different particle diameters are contained in a filler layer facing a negative electrode to non-uniformize a surface of the filler layer. The pouch-shaped secondary battery has flexibility, and may be deformed due to expansion and contraction of the electrode assembly with charge and discharge. Patent Literature 1 describes that non-uniformizing the surface of the filler layer generates a gap, and this gap absorbs the expansion of the negative electrode during charge to inhibit increase in a thickness of the electrode assembly.

### CITATION LIST

### Patent Literature

PATENT LITERATURE 1: Japanese Unexamined Patent Application Publication No. 2021-501453

### SUMMARY

In the non-aqueous electrolyte secondary battery in which the electrode assembly is housed in a metallic exterior, when the electrode assembly expands with a charge-discharge cycle, a pressure may be applied on the electrode assembly from the exterior to cause electrode deformation that is bending of the electrode plate. The electrode deformation can be a cause of internal short circuit, and thus inhibition of the electrode deformation is an important challenge. In addition, the separator has a function of retaining an electrolyte solution, and is required to have improved liquid permeability from the viewpoint of improvement of productivity of the secondary battery. The art disclosed in Patent Literature 1 does not investigate the inhibition of the electrode deformation and the improvement of the liquid permeability, and still has room for improvement.

An object of the present disclosure is to provide a non-aqueous electrolyte secondary battery with improved liquid permeability while inhibiting the electrode deformation.

A non-aqueous electrolyte secondary battery of an aspect of the present disclosure comprises: an electrode assembly in which a positive electrode and a negative electrode are wound with a separator interposed therebetween; an electrolyte solution; and an exterior housing can that houses the electrode assembly and the electrolyte solution, wherein the separator has a substrate layer and a filler layer formed on at least one surface of the substrate layer, the filler layer includes inorganic particles and resin particles having an average particle diameter larger than that of the inorganic particles, the projections project from an inorganic particle layer formed with the inorganic particles excluding the projections in the filler layer, and when a surface of the filler layer is observed with a scanning electron microscope, greater than or equal to 10 and less than or equal to 35 of the resin particles forming the projections are detected in a region of 100 μm×100 μm.

According to the non-aqueous electrolyte secondary battery of the present disclosure, the liquid permeability can be improved while inhibiting the electrode deformation. This can improve safety and productivity of the non-aqueous electrolyte secondary battery.

### BRIEF DESCRIPTION OF DRAWING

FIG. 1 is a vertical sectional view of a cylindrical secondary battery of an example of an embodiment.

FIG. 2 is a sectional view of a separator of an example of an embodiment.

FIG. 3 is a view for describing a method for evaluating deformation of an electrode.

### DESCRIPTION OF EMBODIMENTS

Hereinafter, an example of an embodiment of a non-aqueous electrolyte secondary battery according to the present disclosure will be described in detail with reference to the drawings. Hereinafter, a cylindrical secondary battery in which an electrode assembly is housed in a cylindrical exterior housing can will be exemplified, but the exterior housing can is not limited to the cylindrical exterior housing can, and may be a rectangular exterior housing can, a coin-shaped exterior housing can, or the like, for example. In the following description, specific shapes, materials, values, directions, and the like, which are examples for facilitating understanding of the present disclosure, may be appropriately modified with specifications of non-aqueous electrolyte secondary batteries. When a plurality of embodiments and modified examples are included in the following description, use in appropriate combination of characteristic portions thereof is anticipated in advance.

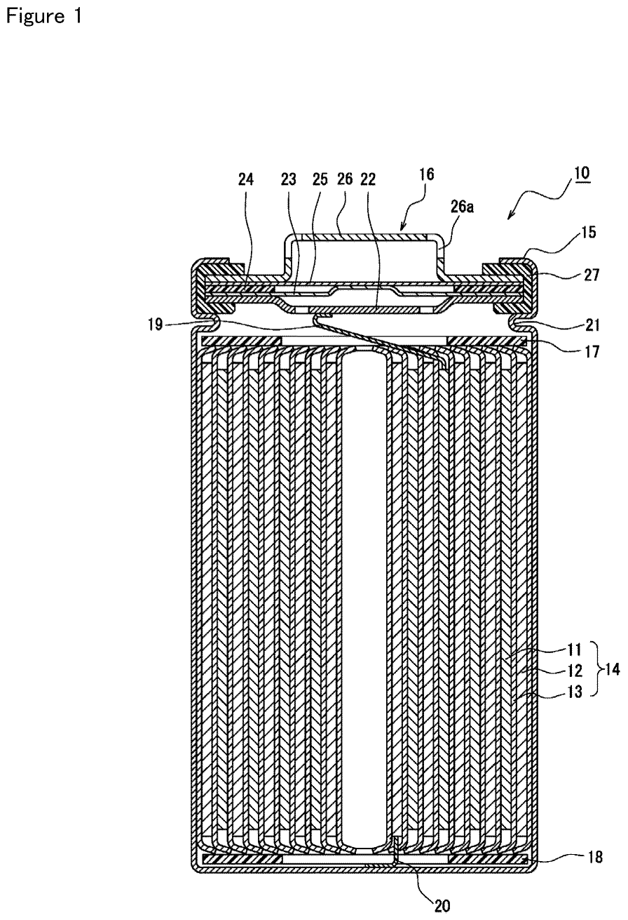

FIG. 1 is a vertical sectional view of a cylindrical secondary battery 10 of an example of an embodiment. In the cylindrical secondary battery 10 illustrated in FIG. 1, an electrode assembly 14 and an electrolyte solution (not illustrated) are housed in an exterior housing can 15. Hereinafter, for convenience of description, a direction along an axial direction of the exterior housing can 15 will be described as “the vertical direction or the upper-lower direction”, a side of a sealing assembly 16 will be described as “the upper side”, and a side of a bottom of the exterior housing can 15 will be described as “the lower side”.

As a non-aqueous solvent (organic solvent) of the electrolyte solution, carbonates, lactones, ethers, ketones, esters, and the like may be used, and two or more of these solvents may be mixed for use. When two or more of the solvents are mixed for use, a mixed solvent including a cyclic carbonate and a chain carbonate is preferably used. For example, ethylene carbonate (EC), propylene carbonate (PC), butylene carbonate (BC), or the like may be used as the cyclic carbonate, and dimethyl carbonate (DMC), ethyl methyl carbonate (EMC), diethyl carbonate (DEC), or the like may be used as the chain carbonate. As the esters, carbonate esters such as methyl acetate (MA) and methyl propionate (MP) are preferably used. The non-aqueous solvent may contain a halogen-substituted derivative in which hydrogen atoms of these solvents are at least partially substituted with a halogen atom such as fluorine. As the halogen-substituted derivative, fluoroethylene carbonate (FEC), methyl fluoropropionate (FMP), and the like are preferably used, for example. As an electrolyte salt in the electrolyte solution, LiPF₆, LiBF₄, LiCF₃SO₃, lithium bis (fluorosulfonyl) imide, lithium bis (trifluoromethanesulfonyl) imide, and the like, and a mixture thereof may be used. The amount of the electrolyte salt to be dissolved in the non-aqueous solvent is, for example, greater than or equal to 0.5 mol/L and less than or equal to 2.0 mol/L.

The electrode assembly 14 has a wound structure in which a band-shaped positive electrode 11 and a band-shaped negative electrode 12 are wound with a separator 13 interposed therebetween. All of the positive electrode 11, negative electrode 12, and separator 13 have an elongated band-shape, and are spirally wound to be alternately stacked in a radial direction of the electrode assembly 14. In the electrode assembly 14, the positive electrode 11, the negative electrode 12, and the separator 13 are wound with greater than or equal to 10 rounds and less than or equal to 30 rounds, for example. To prevent precipitation of lithium, the negative electrode 12 is formed to be one size larger than the positive electrode 11. That is, the negative electrode 12 is formed to be longer than the positive electrode 11 in a longitudinal direction and a width direction (short direction). Two of the separators 13 are formed to be one size larger than the positive electrode 11 and the negative electrode 12, and disposed to sandwich the positive electrode 11. A positive electrode lead 19 is connected to a substantial center in the longitudinal direction of the positive electrode 11 by welding or the like, and a negative electrode lead 20 is connected to an inner end of winding of the negative electrode 12 by welding or the like.

Insulating plates 17 and 18 are respectively disposed on the upper and lower sides of the electrode assembly 14. In the example illustrated in FIG. 1, the positive electrode lead 19 extends through a through hole in the insulating plate 17 toward a side of the sealing assembly 16, and is connected to a lower surface of a filter 22 of the sealing assembly 16 by welding or the like. In the secondary battery 10, a cap 26, which is a top plate of the sealing assembly 16 electrically connected to the filter 22, becomes a positive electrode terminal. On the other hand, the negative electrode lead 20 extends through a through hole of the insulating plate 18 toward the bottom side of the exterior housing can 15, and is connected to a bottom inner face of the exterior housing can 15 by welding or the like. In the secondary battery 10, the exterior housing can 15 becomes a negative electrode terminal. When the negative electrode lead 20 is provided on an outer end of winding, the negative electrode lead 20 extends through an outside of the insulating plate 18 toward the bottom side of the exterior housing can 15, and welded to a bottom inner face of the exterior housing can 15.

As noted above, the exterior housing can 15 is a bottomed cylindrical metallic container with an opening on one side in the axial direction. A gasket 27 is provided between the exterior housing can 15 and the sealing assembly 16 to achieve sealability inside the battery and insurability between the exterior housing can 15 and the sealing assembly 16. On the exterior housing can 15, a grooved portion 21 in which a part of a side wall projects inward to support the sealing assembly 16 is formed. The grooved portion 21 is preferably formed in a circular shape along a circumferential direction of the exterior housing can 15, and supports the sealing assembly 16 with the upper face thereof. The sealing assembly 16 is fixed on the upper part of the exterior housing can 15 with the grooved portion 21 and with an end of the opening of the exterior housing can 15 caulked with the sealing assembly 16.

The sealing assembly 16 has a stacked structure of the filter 22, a lower vent member 23, an insulating member 24, an upper vent member 25, and the cap 26 in this order from the electrode assembly 14 side. Each member constituting the sealing assembly 16 has, for example, a disk shape or a ring shape, and each member except for the insulating member 24 is electrically connected to each other. The lower vent member 23 and the upper vent member 25 are connected at each of central parts thereof, and the insulating member 24 is interposed between each of the circumferential parts. If the internal pressure increases due to battery abnormality, the lower vent member 23 is deformed so as to push the upper vent member 25 up toward the cap 26 side and breaks, and thereby a current pathway between the lower vent member 23 and the upper vent member 25 is cut off. If the internal pressure further increases, the upper vent member 25 breaks, and gas is discharged through an opening 26a of the cap 26.

Hereinafter, the positive electrode 11, the negative electrode 12, and the separator 13 that constitute the electrode assembly 14, specifically the separator 13, will be described in detail.

### [Positive Electrode]

The positive electrode 11 has a positive electrode current collector and a positive electrode mixture layer formed on a surface of the positive electrode current collector. For the positive electrode current collector, a foil of a metal stable within a potential range of the positive electrode, such as aluminum, a film in which such a metal is disposed on a surface layer, or the like may be used. A thickness of the positive electrode current collector is, for example, greater than or equal to 10 μm and less than or equal to 30 μm.

The positive electrode mixture layer is preferably formed on both surfaces of the positive electrode current collector. A thickness of the positive electrode mixture layer is, for example, greater than or equal to 10 μm and less than or equal to 150 μm on one side of the positive electrode current collector. The positive electrode mixture layer includes, for example, a positive electrode active material, a conductive agent, and a binder. The positive electrode may be produced by, for example, applying a positive electrode mixture slurry including the positive electrode active material, the conductive agent, the binder, and the like on both the surfaces of the positive electrode current collector, drying the coating, and subsequently rolling the coating by using a roller or the like.

Examples of the positive electrode active material included in the positive electrode mixture layer may include a lithium-transition metal composite oxide containing a transition metal element such as Co, Mn, and Ni. The lithium-transition metal composite oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M; at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly, or as a mixture thereof.

In terms of increase in the capacity of the non-aqueous electrolyte secondary battery, the positive electrode active material preferably includes a lithium-nickel composite oxide. Examples of the lithium-nickel composite oxide may include LiₓNiO₂, LiₓCo_{y}Ni_{1-y}O₂, and LiₓNi_{1-y}M_{y}O_{z}, wherein M represents at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3. A lithium-nickel composite oxide having a higher content rate of Ni has higher capacity.

Examples of the conductive agent included in the positive electrode mixture layer include carbon-based particles such as carbon black (CB), acetylene black (AB), Ketjenblack, carbon nanotube (CNT), graphene, and graphite. These may be used singly, or in combination of two or more.

Examples of the binder included in the positive electrode mixture layer include fluororesins such as polytetrafluoroethylene (PTFE) and polyvinylidene fluoride (PVDF), polyacrylonitrile (PAN), polyimide resins, acrylic resins, and polyolefin resins. These may be used singly, or in combination of two or more.

### [Negative Electrode]

The negative electrode 12 has a negative electrode current collector and a negative electrode mixture layer formed on a surface of the negative electrode current collector. For the negative electrode current collector, a foil of a metal stable within a potential range of the negative electrode, such as copper, a film in which such a metal is disposed on a surface layer, or the like may be used. A thickness of the negative electrode current collector is, for example, greater than or equal to 5 μm and less than or equal to 30 μm.

The negative electrode mixture layer is preferably formed on both surfaces of the negative electrode current collector. A thickness of the negative electrode mixture layer is, for example, greater than or equal to 10 μm and less than or equal to 150 μm on one side of the negative electrode current collector. The negative electrode mixture layer includes, for example, a negative electrode active material and a binder. The negative electrode may be produced by, for example, applying a negative electrode mixture slurry including the negative electrode active material, the binder, and the like on both the surfaces of the negative electrode current collector, drying the coating, and subsequently rolling the coating by using a roller or the like.

The negative electrode active material included in the negative electrode mixture layer is not particularly limited as long as it may reversibly occlude and release lithium ions, and a carbon material such as graphite is typically used. The graphite may be any of: a natural graphite such as flake graphite, massive graphite, and amorphous graphite;

and an artificial graphite such as massive artificial graphite and graphitized mesophase-carbon microbead.

As the negative electrode active material, a metal that forms an alloy with Li, such as Si or Sn, a metal compound including Si, Sn, or the like, a lithium-titanium composite oxide, or the like may be used. For example, a Si-containing compound represented by SiOₓ (0.5≤x≤1.6); or a Si-containing compound in which Si fine particles are dispersed in a lithium silicate phase represented by Li_{2y}SiO_{(2+y)} (0<y<2) may be used in combination with graphite.

Since the Si-containing compound has a large proportion of expansion and contraction due to charge and discharge of the battery, the electrode deformation tends to occur when the negative electrode 12 includes the Si-containing compound. Thus, when the negative electrode 12 includes the Si-containing compound, an effect by the separator 13 described later becomes remarkable.

Examples of the binder included in the negative electrode mixture layer include styrene-butadiene rubber (SBR), nitrile-butadiene rubber (NBR), carboxymethylcellulose (CMC) or a salt thereof, polyacrylic acid (PAA) or a salt thereof (which may be PAA-Na, PAA-K, and the like, or a partially neutralized salt), and polyvinyl alcohol (PVA). These materials may be used singly, or in combination of two or more.

### [Separator]

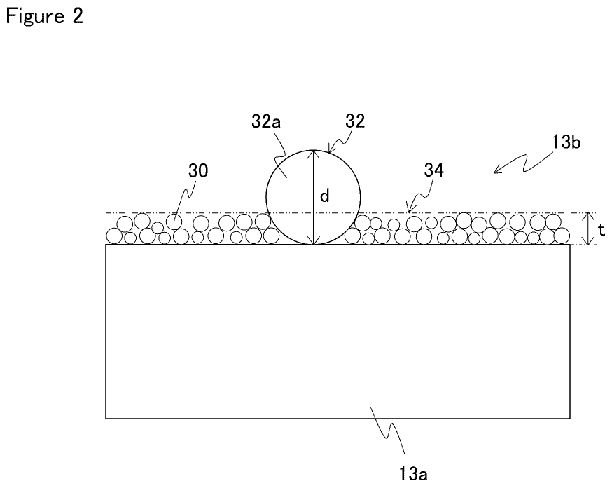

The separator 13 separates the positive electrode 11 and the negative electrode 12 from each other, and inhibits contact between the positive electrode 11 and the negative electrode 12 to cause short circuit. FIG. 2 is a sectional view of the separator 13 of an example of an embodiment. In the example illustrated in FIG. 2, the positive electrode 11 is disposed on the upper side of the separator 13, and the negative electrode 12 is disposed on the lower side.

As illustrated in FIG. 2, the separator 13 has a substrate layer 13a and a filler layer 13b formed on at least one surface of the substrate layer 13a. In the present embodiment, the filler layer 13b faces the positive electrode 11, and the substrate layer 13a faces the negative electrode 12. The separator 13 is not limited to this example, and the filler layer 13b may face the negative electrode 12, and the substrate layer 13a may face the positive electrode 11. The separator 13 may have the filler layer 13b on both the surfaces of the substrate layer 13a.

As the substrate layer 13a, a porous sheet having an ion permeation property and an insulation property is used, for example. Specific examples of the porous sheet include a fine porous thin film, a woven fabric, and a nonwoven fabric. A material of the substrate layer 13a is not particularly limited, and examples thereof may include polyolefins such as polyethylene, polypropylene, and a copolymer of polyethylene and an α-olefin, an acrylic resin, polystyrene, a polyester, cellulose, a polyimide, polyphenylene sulfide, polyether ether ketone, and a fluororesin. The substrate layer 13a may have a single-layered structure, or may have a stacked structure. A thickness of the substrate layer 13a is preferably greater than or equal to 3 μm and less than or equal to 20 μm, and more preferably greater than or equal to 5 μm and less than or equal to 15 μm.

The filler layer 13b includes inorganic particles 30 and resin particles 32 having an average particle diameter larger than that of the inorganic particles 30. The filler layer 13b has projections 32a formed with the resin particles 32, and the projections 32a project from an inorganic particle layer 34 formed with the inorganic particles 30 in the filler layer 13b. The inorganic particle layer 34 is a layer formed by aggregation of the inorganic particles 30, and formed in a region excluding the projections 32a in the filler layer 13b. In FIG. 2, the inorganic particles 30 are stacked with substantially two steps in a thickness direction of the separator 13, but the inorganic particles 30 are not limited to this example. The inorganic particles 30 may be present with only one step in the thickness direction of the separator 13, or may be stacked with greater than or equal to two steps.

As illustrated in FIG. 2, a particle diameter “d” of the resin particles 32 in the thickness direction of the separator 13 is larger than a thickness “t” of the inorganic particle layer 34. According to this, an upper part of the resin particles 32 forming the projections 32a projects from the inorganic particle layer 34. The resin particles 32 may contact with the substrate layer 13a. A cross section of the resin particles 32 may be a circular shape or an oval shape.

An average particle diameter (D50) of the resin particles 32 is preferably larger than the thickness “t” of the inorganic particle layer 34 by greater than or equal to 1 μm and less than or equal to 10 μm. When the difference between the D50 of the resin particles 32 and the thickness “t” of the inorganic particle layer 34 is within this range, the effect of inhibiting the electrode deformation and the effect of improving liquid permeability by the separator 13 become more remarkable. D50 of the inorganic particles 30 is, for example, greater than or equal to 0.3 μm and less than or equal to 0.8 μm. The average particle diameter (D50) herein means a particle diameter at which a cumulative frequency is 50% from a smaller particle diameter side in volume-based particle size distribution, and also referred to as “median diameter”. The particle size distribution of the inorganic particles may be measured by using a laser diffraction-type particle size distribution measuring device (for example, MT3000II, manufactured by MicrotracBEL Corp.) with water as a dispersion medium.

When the surface of the filler layer 13b is observed with a scanning electron microscope (SEM, for example, SU8220, manufactured by Hitachi High-Tech Corporation), greater than or equal to 10 and less than or equal to 35 of the resin particles 32 forming the projections 32a are detected in a region of 100 μm×100 μm. According to this, internal stress generated by expansion and contraction of the positive electrode 11 and the negative electrode 12 in charge and discharge of the secondary battery 10 can be relaxed, and thereby the electrode deformation can be inhibited. Here, the electrode deformation refers to bending of at least one of the pair of the electrodes (the positive electrode 11 and the negative electrode 12).

If the number of the detected resin particles forming the projections 32a is less than 10, the effect of inhibiting the electrode deformation is not sufficiently exhibited. If the number of the detected resin particles 32 forming the projections 32a is greater than 35, the liquid permeability is not sufficiently improved.

The projections 32a have, for example, a size so as to be detectable by SEM observation with magnifying the surface of the filler layer 13b with 1000 times. In the surface of the filler layer 13b, a region of 100 μm×100 μm is observed to count the number of the resin particles 32 forming the projections 32a. The observation is performed in different three regions, and an average value of the numbers detected in the regions is specified as the number of the resin particles 32 forming the projections 32a per predetermined area (100 μm×100 μm).

Examples of a material of the resin particles 32 include: acrylic resins composed of an ethylenically unsaturated carboxylic acid alkyl ester such as methyl acrylate, butyl acrylate, ethyl acrylate, and 2-ethylhexyl acrylate; resins composed of a cyano-group-containing ethylenically unsaturated monomer such as acrylonitrile; and resins composed of an ethylenically unsaturated carboxylic acid such as acrylic acid, methacrylic acid, and maleic acid, and a salt thereof.

The resin particles 32 have adhesiveness to the positive electrode 11, and in the secondary battery 10, the resin particles 32 preferably adhere to the positive electrode. The resin particles 32 adhering to the positive electrode 11 allows the effect of reducing the internal stress of the electrode assembly 14 to be more remarkable when the electrode assembly 14 expands due to charge and discharge. The resin particles 32 exhibit the adhesiveness to the positive electrode 11 when holding the electrolyte solution, for example.

Examples of the inorganic particles 30 include metal oxide particles, metal nitride particles, metal fluoride particles, and metal carbide particles. Examples of the metal oxide particles include aluminum oxide, titanium oxide, magnesium oxide, zirconium oxide, nickel oxide, silicon oxide, and manganese oxide. Examples of the metal nitride particles include titanium nitride, boron nitride, aluminum nitride, magnesium nitride, and silicon nitride. Examples of the metal fluoride particles include aluminum fluoride, lithium fluoride, sodium fluoride, magnesium fluoride, calcium fluoride, and barium fluoride. Examples of the metal carbide particles include silicon carbide, boron carbide, titanium carbide, and tungsten carbide. The inorganic particles 30 may also be a porous aluminosilicate salt such as zeolite (M_{2/n}O·Al₂O₃·xSiO₂·yH₂O, wherein M represents a metal element, n represents a valency of M, x≥2, and y≥0), a layered silicate salt such as talc (Mg₃Si₄O₁₀(OH)₂), and minerals such as barium titanate (BaTiO₃) and strontium titanate (SrTiO₃). These may be used singly, or may be used in combination of two or more thereof.

The filler layer 13b may further include a binder. The binder has a function of adhesion between the fillers each other and between the filler and the substrate layer in the inorganic particles 30 and the resin particles 32 as the filler. The binder is preferably a polymer material, and examples thereof may include fluororesins such as polyvinylidene fluoride (PVDF) and polytetrafluoroethylene (PTFE), polyimide resins, polyamide resins, acrylic resins, polyolefin resins, styrene-butadiene rubber (SBR), nitrile-butadiene rubber (NBR), carboxymethylcellulose (CMC) or a salt thereof, polyacrylic acid (PAA) or a salt thereof, and polyvinyl alcohol (PVA). These may be used singly, or in combination of two or more.

In the filler layer 13b, a content of the resin particles 32 is, for example, greater than or equal to 1 part by mass and less than or equal to 10 parts by mass, and a content of the binder is, for example, greater than or equal to 1 part by mass and less than or equal to 10parts by mass when the content of the inorganic particles 30 is 100 parts by mass.

### EXAMPLES

Hereinafter, the present disclosure will be further described with Examples, but the present disclosure is not limited to these Examples.

### Example

[Production of Positive Electrode]

As a positive electrode active material, aluminum-containing lithium nickel cobaltate represented by LiNi_{0.88}Co_{0.09}Al_{0.03}O₂ was used. 100 parts by mass of positive electrode active material, 1 part by mass of acetylene black (AB), and 0.9 part by mass of polyvinylidene fluoride (PVDF) were mixed, and an appropriate amount of N-methyl-2-pyrrolidone (NMP) was added to prepare a positive electrode mixture slurry. Then, this positive electrode mixture slurry was applied to both surfaces of a band-shaped positive electrode current collector made of aluminum foil and having a thickness of 15 μm, the coating was dried and subsequently rolled, and cut to a predetermined electrode size to produce a positive electrode in which positive electrode mixture layers were formed on both the surfaces of the positive electrode current collector. On a substantial center in a longitudinal direction of the positive electrode, a positive electrode exposed portion where the mixture layer was absent and the current collector surface was exposed was provided, and a positive electrode lead made of aluminum was welded with the positive electrode exposed portion.

### [Production of Negative Electrode]

Mixing 95 parts by mass of graphite, 5 parts by mass of Si oxide (SiO), 1 part by mass of sodium carboxymethylcellulose (CMC-Na), and 1 part by mass of styrene-butadiene rubber (SBR) was performed, and an appropriate amount of water was added to prepare a negative electrode mixture slurry. Then, this negative electrode mixture slurry was applied to both surfaces of a band-shaped negative electrode current collector made of copper foil and having a thickness of 8 μm, the coating was dried and subsequently rolled, and cut to a predetermined electrode size to produce a negative electrode in which negative electrode mixture layers were formed on both the surfaces of the negative electrode current collector. On an inner end of winding of the negative electrode, a negative electrode exposed portion where the mixture layer was absent and the current collector surface was exposed was provided, and a negative electrode lead made of nickel was welded with the negative electrode exposed portion.

### [Production of Separator]

As a substrate layer, a porous substrate made of polyethylene with a thickness of 12 μm was used. Alumina (α-Al₂O₃) particles having an average particle diameter (D50) of 0.7 μm as inorganic particles, acrylic resin particles having D50 of 4 μm as resin particles, and an acrylate ester-based binder emulsion were mixed at a solid-content mass ratio of 100:2:3, and then an appropriate amount of water was added so that the solid-content concentration was 10 mass % to prepare a dispersion. This dispersion was applied on an entire surface of the porous substrate as the substrate layer by using a micro gravure coater.

Thereafter, the coating film was heated and dried with an oven at 50° C. for 4 hours to form a filler layer having projections in which the acrylic resin particles projected from a surface of an inorganic particle layer with a thickness of 3 μm formed with α-Al₂O₃. As a result of observation using a scanning electron microscope (SU8220, manufactured by Hitachi High-Tech Corporation), the number of the resin particles forming the projections per predetermined area (100 μm×100 μm) was 10.

### [Preparation of Electrolyte Solution]

Into 100 parts by mass of a mixed solvent in which ethylene carbonate (EC) and dimethyl carbonate (DMC) were mixed at a volume ratio of 3:7, 5 parts by mass of vinylene carbonate (VC) was added, and lithium hexafluorophosphate (LiPF₆) was dissolved at a concentration of 1.5 mol/L to prepare an electrolyte solution.

### [Production of Secondary Battery]

The positive electrode and the negative electrode were spirally wound with the separator interposed therebetween to produce a wound electrode assembly. In this time, the filler layer of the separator faced the positive electrode. Insulating plates were respectively disposed on the upper and lower sides of the electrode assembly, and the electrode assembly was housed in an exterior housing can. A negative electrode lead was welded to a bottom of the bottomed cylindrical exterior housing can, and a positive electrode lead was welded to a sealing assembly. The electrolyte solution was injected into the exterior housing can, then an opening of the exterior housing can was sealed with the sealing assembly via a gasket, and left to stand in a thermostatic chamber at 60° C. for 15 hours to produce a non-aqueous electrolyte secondary battery. A capacity of the produced secondary battery was 4600 mAh.

### [Evaluation of Liquid Permeability]

When the electrolyte solution was injected into the exterior housing can in the production of the secondary battery, liquid permeability was evaluated. Measured was a time from injection of the electrolyte solution through the opening of the battery to permeation into the electrolyte assembly and visual disappearance of the electrolyte solution left on the upper part of the electrolyte assembly, and this time was specified as an index of the liquid permeability.

### [Evaluation of Electrode Deformation]

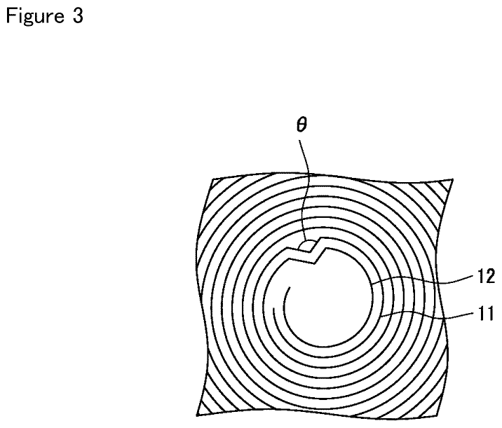

The secondary battery was charged at a constant current of 1380 mA (0.3 It) until a battery voltage reached 4.2 V, and then charged at a constant voltage of 4.2 V until a current reached 92 mA (0.02 It). Thereafter, the battery was discharged at a constant current of 4600 mA (1.0 It) until the battery voltage reached 2.7 V. This charge-discharge cycle was performed with 500 cycles with inserting a rest time for 20 minutes between each of the cycles. The non-aqueous electrolyte secondary battery after the 500 cycles was charged at a constant current of 1380 mA (0.3 It) until the battery voltage reached 4.2 V, and then charged at a constant voltage of 4.2 V until the current reached 92 mA (0.02 It) to prepare a charged state. This non-aqueous electrolyte secondary battery in the charged state was subjected to sectional observation near the winding center of the electrode assembly by using an X-ray CT device (SMX-225CT FPD HR, manufactured by SHIMADZU CORPORATION). As illustrated in FIG. 3, a case where deformation (bending) of an electrode (at least one of the positive electrode and the negative electrode) with an angle θ of less than or equal to 150° was observed was judged as presence of the electrode deformation to evaluate the electrode deformation.

### Example 2

A secondary battery was produced and evaluated in the same manner as in Example 1 except that, in the production of the separator, the mixing ratio of the acrylic resin particles relative to 100 parts by mass of the α-Al₂O₃ particles was changed to 3 parts by mass. As a result of the SEM observation, the number of the resin particles forming the projections per predetermined area (100 μm×100 μm) was 18.

### Example 3

A secondary battery was produced and evaluated in the same manner as in Example 1 except that, in the production of the separator, the mixing ratio of the acrylic resin particles relative to 100 parts by mass of the α-Al₂O₃ particles was changed to 6 parts by mass. As a result of the SEM observation, the number of the resin particles forming the projections per predetermined area (100 μm×100 μm) was 35.

### Example 4

A secondary battery was produced and evaluated in the same manner as in Example 1 except that, in the production of the separator, acrylic resin particles having D50 of 6 μm were used instead of the acrylic resin particles having D50 of 4 μm, and the mixing ratio of the acrylic resin particles relative to 100 parts by mass of the α-Al₂O₃ particles was changed to 5 parts by mass. As a result of the SEM observation, the number of the resin particles forming the projections per predetermined area (100 μm×100 μm) was 25.

### Comparative Example 1

A secondary battery was produced and evaluated in the same manner as in Example 1 except that, in the production of the separator, acrylic resin particles having D50 of 6 μm were used instead of the acrylic resin particles having D50 of 4 μm, and the mixing ratio of the acrylic resin particles relative to 100 parts by mass of the α-Al₂O₃ particles was changed to 3 parts by mass. As a result of the SEM observation, the number of the resin particles forming the projections per predetermined area (100 μm×100 μm) was 5.

### Comparative Example 2

A secondary battery was produced and evaluated in the same manner as in Example 1 except that, in the production of the separator, acrylic resin particles having D50 of 1 μm were used instead of the acrylic resin particles having D50 of 4 μm, and the mixing ratio of the acrylic resin particles relative to 100 parts by mass of the α-Al₂O₃ particles was changed to 2 parts by mass. As a result of the SEM observation, the number of the resin particles forming the projections per predetermined area (100 μm×100 μm) was 8.

### Comparative Example 3

A secondary battery was produced and evaluated in the same manner as in Example 1 except that, in the production of the separator, the mixing ratio of the acrylic resin particles relative to 100 parts by mass of the α-Al₂O₃ particles was changed to 10 parts by mass. As a result of the SEM observation, the number of the resin particles forming the projections per predetermined area (100 μm×100 μm) was 46.

Table 1 shows the evaluation results of the secondary batteries according to Examples and Comparative Examples. The liquid permeability is shown as a value relative to a time when the standard separator was used being 100. Table 1 also shows the D50 of the acrylic resin particles, the mixing ratio of the acrylic resin particles relative to 100 parts by mass of the α-Al₂O₃ particles, and the number of the resin particles forming the projections per predetermined area (100 μm×100 μm).

TABLE 1

| | Resin particles | | | | |
|---|---|---|---|---|---|
| | | Mixing ratio relative to | Number of resin | Liquid- | |
| | D₅₀ | 100 parts by mass of α-Al₂O₃ | particles forming | injecting | Electrode |
| | [μm] | [parts by mass] | projections | property | deformation |
| Example 1 | 4 | 2 | 10 | 94 | Absence |
| Example 2 | 4 | 3 | 18 | 92 | Absence |
| Example 3 | 4 | 6 | 35 | 93 | Absence |
| Example 4 | 6 | 5 | 25 | 92 | Absence |
| Comparative | 6 | 3 | 5 | 95 | Presence |
| Example 1 | | | | | |
| Comparative | 1 | 2 | 8 | 100 | Presence |
| Example 2 | | | | | |
| Comparative | 4 | 10 | 46 | 105 | Absence |
| Example 3 | | | | | |

The secondary batteries of Examples exhibit no electrode deformation, and good liquid permeability. Meanwhile, the secondary batteries of Comparative Examples 1 and 2 exhibit electrode deformation, and the secondary battery of Comparative Example 3 exhibits poor liquid permeability. Therefore, it is understood that the filler layer including the resin particles so that the number of the resin particles forming the projections per predetermined area (100 μm×100 μm) is greater than or equal to 10 and less than or equal to 35 improves the liquid permeability while inhibiting the electrode deformation.

The present disclosure will be further described with the following embodiments.

### Constitution 1:

A non-aqueous electrolyte secondary battery, comprising:

an electrode assembly in which a positive electrode and a negative electrode are wound with a separator interposed therebetween;

an electrolyte solution; and

an exterior housing can that houses the electrode assembly and the electrolyte solution, wherein

the separator has a substrate layer and a filler layer formed on at least one surface of the substrate layer,

the filler layer includes inorganic particles and resin particles having a particle diameter larger than that of the inorganic particles, and the filler layer has projections formed with the resin particles,

the projections project from an inorganic particle layer formed with the inorganic particles excluding the projections in the filler layer, and

when a surface of the filler layer is observed with a scanning electron microscope, greater than or equal to 10 and less than or equal to 35 of the resin particles forming the projections are detected in a region of 100 μm×100 μm.

### Constitution 2:

The non-aqueous electrolyte secondary battery according to Constitution 1, wherein the average particle diameter of the resin particles is larger than a thickness of the inorganic particle layer by greater than or equal to 1 μm and less than or equal to 10 μm.

### Constitution 3:

The non-aqueous electrolyte secondary battery according to Constitution 1 or 2, wherein the inorganic particles contact with the substrate layer.

### Constitution 4:

The non-aqueous electrolyte secondary battery according to any one of Constitutions 1 to 3, wherein the resin particles adhere to the positive electrode.

### REFERENCE SIGNS LIST

10 Secondary battery,
11 Positive electrode,
12 Negative electrode,

### 13 Separator,

13a Substrate layer,
13b Filler layer,
14 Electrode assembly,
15 Exterior housing can,
16 Sealing assembly,
17, 18 Insulating plate,
19 Positive electrode lead,
20 Negative electrode lead,
21 Grooved portion,

### 22 Filter,

23 Lower vent member,
24 Insulating member,
25 Upper vent member,

### 26 Cap,

### 26a Opening,

### 27 Gasket,

30 Inorganic particle,
32 Resin particle,
34 Inorganic particle layer

1. A non-aqueous electrolyte secondary battery, comprising:
an electrode assembly in which a positive electrode and a negative electrode are wound with a separator interposed therebetween;
an electrolyte solution; and
an exterior housing can that houses the electrode assembly and the electrolyte solution, wherein
the separator has a substrate layer and a filler layer formed on at least one surface of the substrate layer,
the filler layer includes inorganic particles and resin particles having an average particle diameter larger than that of the inorganic particles, and the filler layer has projections formed with the resin particles,
the projections project from an inorganic particle layer formed with the inorganic particles excluding the projections in the filler layer, and
when a surface of the filler layer is observed with a scanning electron microscope, greater than or equal to 10 and less than or equal to 35 of the resin particles forming the projections are detected in a region of 100 μm×100 μm.

2. The non-aqueous electrolyte secondary battery according to claim 1, wherein the average particle diameter of the resin particles is larger than a thickness of the inorganic particle layer by greater than or equal to 1 μm and less than or equal to 10 μm.

3. The non-aqueous electrolyte secondary battery according to claim 1, wherein the inorganic particles contact with the substrate layer.

4. The non-aqueous electrolyte secondary battery according to claim 1, wherein the resin particles adhere to the positive electrode.
